(19) United States
(12) Patent Application Publication
(10) Pub. No.: US 2025/0298620 A1
(43) Pub. Date: Sep. 25, 2025

(54) APPARATUS, APPARATUS CONTROL METHOD, AND RECORDING MEDIUM

(71) Applicant: CASIO COMPUTER CO., LTD., Tokyo (JP)

(72) Inventor: Takeo ISHIZU, Tokyo (JP)

(73) Assignee: CASIO COMPUTER CO., LTD., Tokyo (JP)

(21) Appl. No.: 19/013,830

(22) Filed: Jan. 8, 2025

(30) Foreign Application Priority Data
Mar. 25, 2024 (JP) 2024-048012

(51) Int. Cl. G06F 9/30; G06F 1/26

(52) U.S. Cl. CPC G06F 9/30189; G06F 1/263

(57) ABSTRACT

An apparatus comprises an operation switch to switch power from ON to OFF, and at least one processor. The at least one processor switches, in response to detecting a remaining battery level of a battery being increased to a predetermined first value by charging to the battery in a state where the power is OFF and an automatic startup flag is ON, the power from OFF to ON to start the apparatus. The at least one processor maintains, in response to detecting the remaining battery level being increased to the predetermined first value by charging to the battery in a state where the power is OFF and the automatic startup flag is OFF, the power at OFF not to start the apparatus.

### CROSS-REFERENCE TO RELATED APPLICATIONS

This application is based upon and claims the benefit of priority under 35 USC 119 of Japanese Patent Application No. 2024-048012, filed on Mar. 25, 2024, the entire disclosure of which, including the description, claims, drawings, and abstract, is incorporated herein by reference in its entirety.

### FIELD OF THE INVENTION

The present disclosure relates to an apparatus, an apparatus control method, and a recording medium.

### BACKGROUND OF THE INVENTION

A battery-powered apparatus needs to be, for a stable operation, turned off to charge its battery if a remaining battery level becomes low. For example, Unexamined Japanese Patent Application Publication No. 2007-066060 discloses an information apparatus that is supplied with power from a portable power supply. The information apparatus comprises: an operating section SW that switches between receiving and cutoff of power from an external power receiving section and a non-portable power supply; a determining section that determines, in response to a startup of the information apparatus by supplying of the power, whether the startup is a first startup after shipment of the information apparatus from a factory; a connection detecting section that detects, in response to a determination that the startup is the first startup after the shipment of the information apparatus from the factory, whether the external power receiving section is connected to the non-portable power supply; and an informing section that prompts, in response to a determination that the startup is the first startup after the shipment of the information apparatus from the factory and the external power receiving section being detected as not being connected to the non-portable power supply, a user to connect the external power receiving section to the non-portable power supply.

### SUMMARY OF THE INVENTION

An apparatus according to an embodiment of the present disclosure comprises:
an operation switch to switch power from ON to OFF; and
at least one processor, wherein
the at least one processor
sets, in response to the power being switched from ON to OFF by an operation on the operation switch in a state where an inspection mode flag is ON, an automatic startup flag to ON,
sets, in response to the power being switched from ON to OFF by the operation on the operation switch in a state where the inspection mode flag is OFF, the automatic startup flag to OFF,
switches, in response to detecting a remaining battery level of a battery being increased to a predetermined first value by charging to the battery in a state where the power is OFF and the automatic startup flag is ON, the power from OFF to ON to start the apparatus, and
maintains, in response to detecting the remaining battery level being increased to the predetermined first value by charging to the battery in a state where the power is OFF and the automatic startup flag is OFF, the power at OFF not to start the apparatus.

An control method according to an embodiment of the present disclosure is:
a control method to be executed by an apparatus comprising an operation switch to switch power from ON to OFF, the control method comprising:
setting, in response to the power being switched from ON to OFF by an operation on the operation switch in a state where an inspection mode flag is ON, an automatic startup flag to ON,
setting, in response to the power being switched from ON to OFF by the operation on the operation switch in a state where the inspection mode flag is OFF, the automatic startup flag to OFF,
switching, in response to detecting a remaining battery level of a battery being increased to a predetermined first value by charging to the battery in a state where the power is OFF and the automatic startup flag is ON, the power from OFF to ON to start the apparatus, and
maintaining, in response to detecting the remaining battery level being increased to the predetermined first value by charging to the battery in a state where the power is OFF and the automatic startup flag is OFF, the power at OFF not to start the apparatus.

A recording medium according to an embodiment of the present disclosure is: a non-transitory computer-readable recording medium storing a program, the program causing a computer of an apparatus comprising an operation switch to switch power from ON to OFF, to execute a control function comprising:
setting, in response to the power being switched from ON to OFF by an operation on the operation switch in a state where an inspection mode flag is ON, an automatic startup flag to ON,
setting, in response to the power being switched from ON to OFF by the operation on the operation switch in a state where the inspection mode flag is OFF, the automatic startup flag to OFF,
switching, in response to detecting a remaining battery level of a battery being increased to a predetermined first value by charging to the battery in a state where the power is OFF and the automatic startup flag is ON, the power from OFF to ON to start the apparatus, and
maintaining, in response to detecting the remaining battery level being increased to the predetermined first value by charging to the battery in a state where the power is OFF and the automatic startup flag is OFF, the power at OFF not to start the apparatus.

### BRIEF DESCRIPTION OF DRAWINGS

A more complete understanding of this application can be obtained when the following detailed description is considered in conjunction with the following drawings, in which:

FIG. 1 illustrates an appearance of a robot according to an embodiment of the present disclosure;

FIG. 2 is a cross-sectional view of the robot according to the embodiment as viewed from the side;

FIG. 3 is a block diagram illustrating a functional configuration of the robot according to the embodiment;

FIG. 4 is a block diagram illustrating a configuration of a power controller of the robot according to the embodiment;

FIG. 5 is a flowchart illustrating an example of power-off processing according to the embodiment; and

FIG. 6 is a flowchart illustrating an example of power-on processing according to the embodiment.

### DETAILED DESCRIPTION OF THE INVENTION

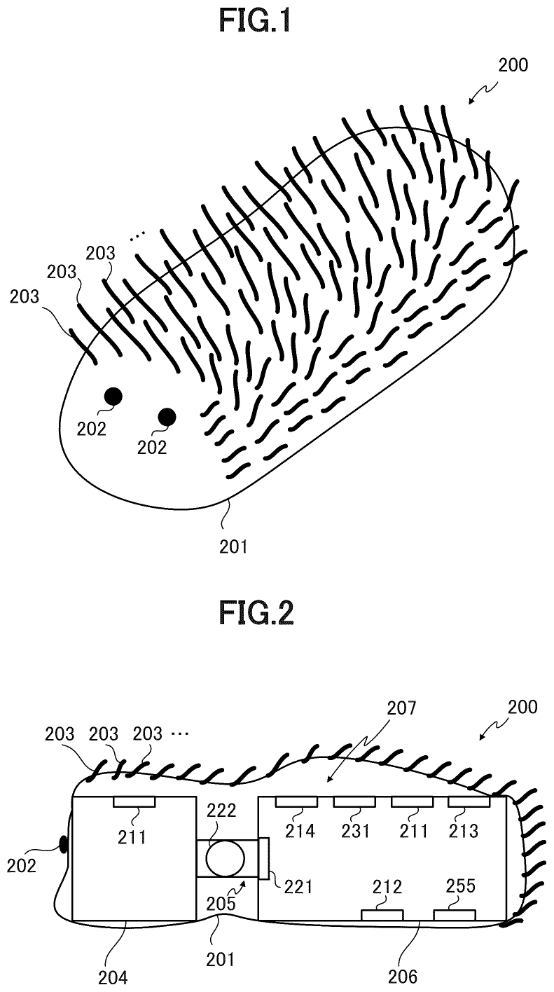

Hereinafter, an embodiments of the present disclosure is described with reference to the drawings. Components identical or corresponding to each other are assigned with the same reference sign in the drawings. A robot 200 according to an embodiment of the present disclosure is a pet robot that is driven by a rechargeable battery and that resembles a small animal. As illustrated in FIG. 1, the robot 200 is covered with an exterior 201 comprising decorative parts 202 resembling eyes and fur 203. As illustrated in FIG. 2, a housing 207 of the robot 200 is accommodated in the exterior 201. The housing 207 of the robot 200 includes a head part 204, a coupling part 205, and a torso part 206, wherein the head part 204 and the torso part 206 are coupled by the coupling part 205.

In the following explanation, assuming that the robot 200 is placed normally on a horizontal floor, a direction toward a portion corresponding to a face of the robot 200 (a portion of the head part 204 on a side opposite to the torso part 206) is a front direction, and a direction toward a portion corresponding to a tail of the robot 200 (a portion of the torso part 206 on a side opposite to the head part 204) is a back direction. Furthermore, a direction toward a portion contacting a floor surface in a case where the robot 200 is placed on the horizontal floor is an upward direction and a direction opposite to said direction is a downward direction. A direction that is orthogonal to a straight line extending in a front-back direction of the robot 200 and is orthogonal to a straight line extending in an up-down direction of the robot 200 is a width direction.

As illustrated in FIG. 2, the torso part 206 extends in the front-back direction. Additionally, the torso part 206 contacts, via the exterior 201, a placement surface such as a floor, a table, or the like on which the robot 200 is placed. The robot 200 is provided with a twist motor 221 at a front end of the torso part 206, and the head part 204 is coupled to the front end of the torso part 206 via the coupling part 205. The coupling part 205 is provided with a vertical motor 222. Although the twist motor 221 is provided in the torso part 206 in FIG. 2, the twist motor 221 may be provided in the coupling part 205 or may be provided in the head part 204.

The robot 200 can move the head part 204 relative to the torso part 206 by use of the twist motor 221 and the vertical motor 222. The robot 200 can execute various actions by moving the head part 204. As illustrated in FIG. 2, the robot 200 is provided with a touch sensor 211 at the head part 204, and can detect petting or striking of the head part 204 by a user. Furthermore, the robot 200 is also provided with a touch sensor 211 at the torso part 206, and can detect petting or striking of the torso part 206 by the user.

The robot 200 is provided with an acceleration sensor 212 at the torso part 206, and can detect an attitude of the robot 200 itself, the robot 200 being picked up by the user, the orientation being changed by the user, or the robot 200 being thrown by the user. Furthermore, the robot 200 is provided with a microphone 213 at the torso part 206, and can detect external sounds. Furthermore, the robot 200 is provided with a speaker 231 at the torso part 206, and can emit the voice of the robot 200 or sing songs by use of the speaker 231.

The robot 200 is provided with an illuminance sensor 214 at the torso part 206, and can detect the surrounding brightness. The exterior 201 is made from a material that transmits light, and thus the robot 200 can detect the surrounding brightness by the illuminance sensor 214 even though the robot 200 is covered by the exterior 201.

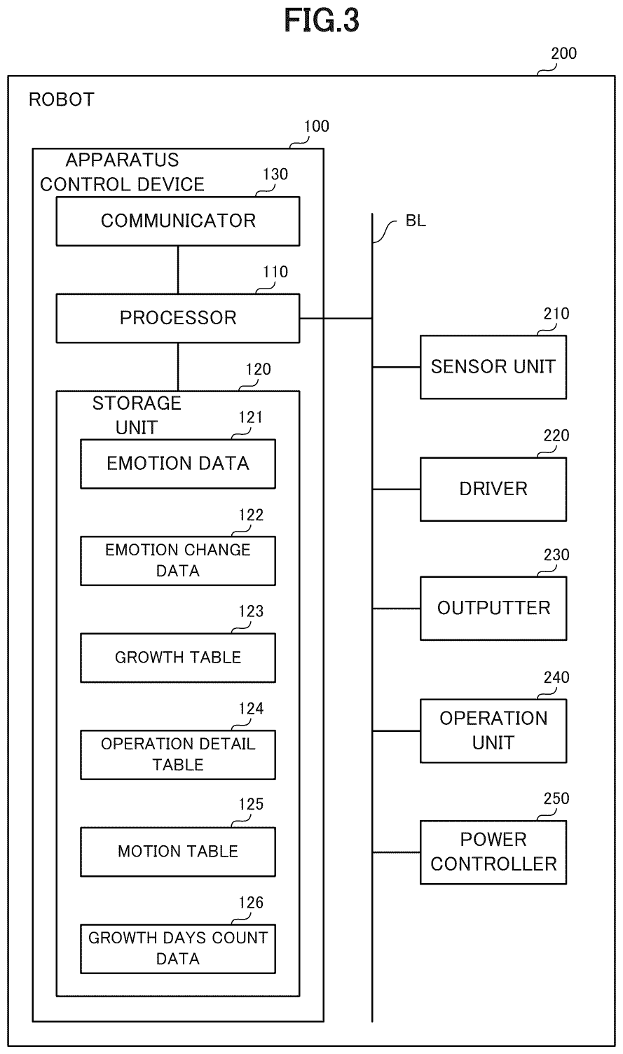

As illustrated in FIG. 3, the robot 200 comprises an apparatus control device 100, a sensor unit 210, a driver 220, an outputter 230, an operation unit 240, and a power controller 250. The apparatus control device 100 comprises a processor 110, a storage unit 120, and a communicator 130. In FIG. 3, the apparatus control device 100 is connected to the sensor unit 210, the driver 220, the outputter 230, the operation unit 240, and the power controller 250 via a bus line BL, but this is merely an example. The apparatus control device 100 may be connected to the sensor unit 210, the driver 220, the outputter 230, the operation unit 240, and the power controller 250 via a wired interface, such as a universal serial bus (USB) cable or the like, or a wireless interface, such as a Bluetooth or the like. Furthermore, the processor 110 may be connected to the storage unit 120 and the communicator 130 via a bus line BL or the like.

The apparatus control device 100 controls operations of the robot 200 by use of the processor 110 and the storage unit 120. The processor 110 comprises, for example, a central processing unit (CPU) or the like, and executes various types of processing by use of programs stored in the storage unit 120. The processor 110 is compatible with a multithreading function for executing a plurality of processing in parallel, and thus can execute various types of processing in parallel. Furthermore, the processor 110 also has a clock function and a timer function, and can measure the date and time, and the like.

The storage unit 120 comprises a read-only memory (ROM), a flash memory, a random access memory (RAM), and the like. The ROM preliminarily stores programs to be executed by the CPU of the processor 110 and data necessary for execution of the programs. The flash memory is a writable non-volatile memory, and stores data that is desirably to be saved even after power-off. The RAM stores data that is created or modified during the execution of the programs. The communicator 130 comprises a communication module compatible with a wireless local area network (LAN), Bluetooth, or the like, and performs data communication with an external device, such as a smartphone.

The illuminance sensor 214 described above comprises a light receiving element such as a photodiode or the like, and detects the surrounding brightness (illuminance). For example, in response to the illuminance sensor 214 detecting that the surroundings are dark, the processor 110 can perform control for putting the robot 200 to pseudo-sleep (setting to a sleep control mode).

The storage unit 120 stores emotion data 121, emotion change data 122, a growth table 123, an operation detail table 124, a motion table 125, and growth days count data 126. The emotion data 121 is data for imparting pseudo-emotions to the robot 200, and is data that represents coordinates on an emotion map. The emotion map is expressed by, for example, a two-dimensional coordinate system having a degree of relaxation (degree of worry) axis, and a degree of excitement (degree of disinterest) axis. The emotion change data 122 is data that sets an amount of change by which a value of each dimension of the emotion data 121 is increased or decreased. The emotion change data 122 is changed by learning of the emotion data 121 based on external stimulus data. Since the learning processing of the emotion data 121 causes the emotion change data 122, that is, degrees of change of emotion, to change, the robot 200 is to have various characters depending on a manner in which the user interacts with the robot 200. In the robot 200, growth degree data (growth value) that indicates a degree of pseudo-growth is set in accordance with a change in characters. The processor 110 performs control so that variation is introduced into the operation detail of the robot 200 in accordance with the pseudo-growth of the robot 200 (as the growth value increases). Data that the processor 110 uses for this purpose is the growth table 123. The operation details table 124 is a table in which specific operation detail of the various action types defined in the growth table 123 is stored. The motion table 125 is a table that stores, for each of the various action types defined in the growth table 123, the manner in which the processor 110 controls the twist motor 221 and the vertical motor 222. The growth days count data 126 has an initial value of 1, and is incremented by one for each passing day. The growth days count data 126 represents a pseudo-growth days count (number of days from a pseudo-birth) of the robot 200.

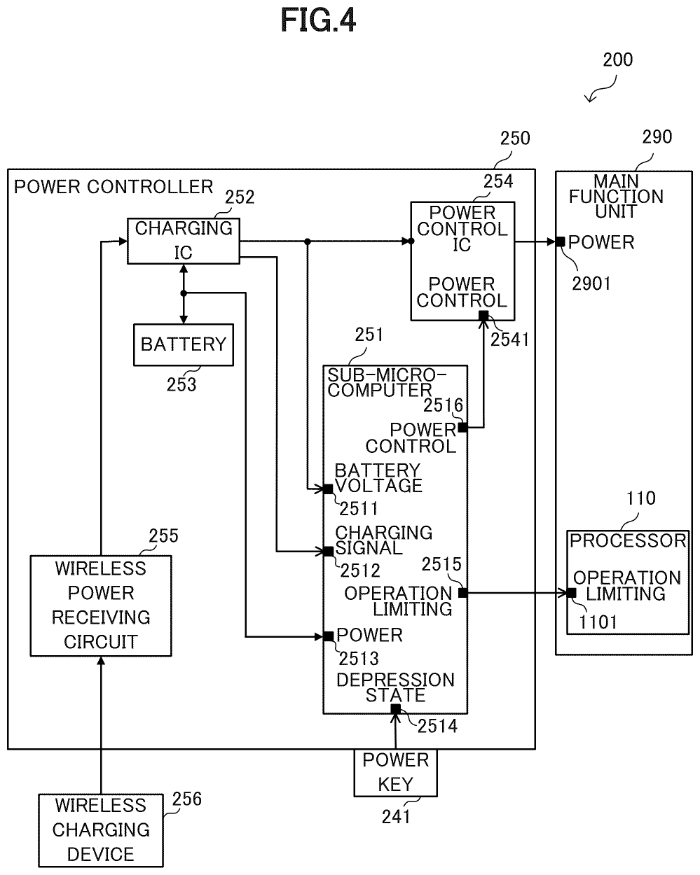

As illustrated in FIG. 4, the power controller 250 comprises a sub-microcomputer 251 and the like, and performs power control such as charging of a battery 253 of the robot 200, power on/off control of a main function unit 290 that realizes main functions of the robot 200. The main function unit 290 is a portion of function units comprising the robot 200, excluding the power controller 250, and comprises the processor 110, the driver 220, and the like.

In the robot 200, in order to imitate a living creature, the battery 253 is charged by wireless charging without being connected to a charging cable or the like. As the wireless charging method, an electromagnetic induction method is used. In response to the robot 200 being placed on a wireless charging device 256, an induced magnetic flux is generated between a wireless power receiving circuit 255 provided on a bottom surface of the torso part 206 and an external wireless charging device 256 to perform charging. As illustrated in FIG. 4, the power controller 250 comprises the sub-microcomputer 251, a charging integrated circuit (IC) 252, the battery 253, a power control IC 254, and the wireless power receiving circuit 255.

The sub-microprocessor 251 is a microcontroller that incorporates a low power consumption processor, and comprises: an analog-to-digital (AD) converter 2511 that monitors output voltage of the battery 253; an input port 2512 that monitors a charging signal indicating whether charging of the battery 253 is being performed in the charging IC 252; a power supply terminal 2513 for the sub-microcomputer 251 itself; an input port 2514 that monitors a depression state of a power key 241 of the robot 200; an output port 2515 that outputs a signal for operation limiting to the processor 110; and an output port 2516 that outputs, to the power control IC 254, a power control signal for controlling on/off of power supplied to the main function unit 290. The sub-microcomputer 251 constitutes a detector that detects a charging state of the battery 253, and a controller that controls power on/off and startup of the robot 200.

The wireless power receiving circuit 255 receives power, by electromagnetic induction, from the external wireless charging device 256, and supplies the received power to the charging IC 252. The charging IC 252 is an IC that receives power from the wireless power receiving circuit 255 and performs control for charging the battery 253. The battery 253 is a rechargeable secondary battery, and supplies power necessary for operation of the robot 200. The charging IC 252 outputs, to the sub-microcomputer 251, a charge signal indicating whether the battery 253 is charging. The power control IC 254 is an IC that controls whether to supply the power from the battery 253 to the main function unit 290 of the robot 200. The power control IC 254 comprises an input port 2541 that receives, from the sub-microcomputer 251, a signal for controlling power, and supplies the power or stops power supply to the main function unit 290 in accordance with on/off of the signal for controlling power.

The power key 241 is a key as a reception means that receives a power-on operation and a power-off operation of the robot 200. Even when the power of the robot 200 is off, power is supplied to the power controller 250 to charge the battery 253 or to perform control of turning on the power of the robot 200 automatically after the charging is completed. Hence, from a standpoint of power supply, the robot 200 comprises two components, that is, the power controller 250 to which power is continuously supplied, and the main function unit 290 of which power on/off is controlled by the power controller 250. The main function unit 290 comprises, among parts comprising the robot 200, parts other than the power controller 250. FIG. 4 shows, in order to illustrate a relationship between the power controller 250 and the main function unit 290, a power supply terminal 2901 to which power is supplied from the power controller 250, and an input port 1101 of the processor 110 that receives a signal for operation limiting transmitted from the sub-microcomputer 251.

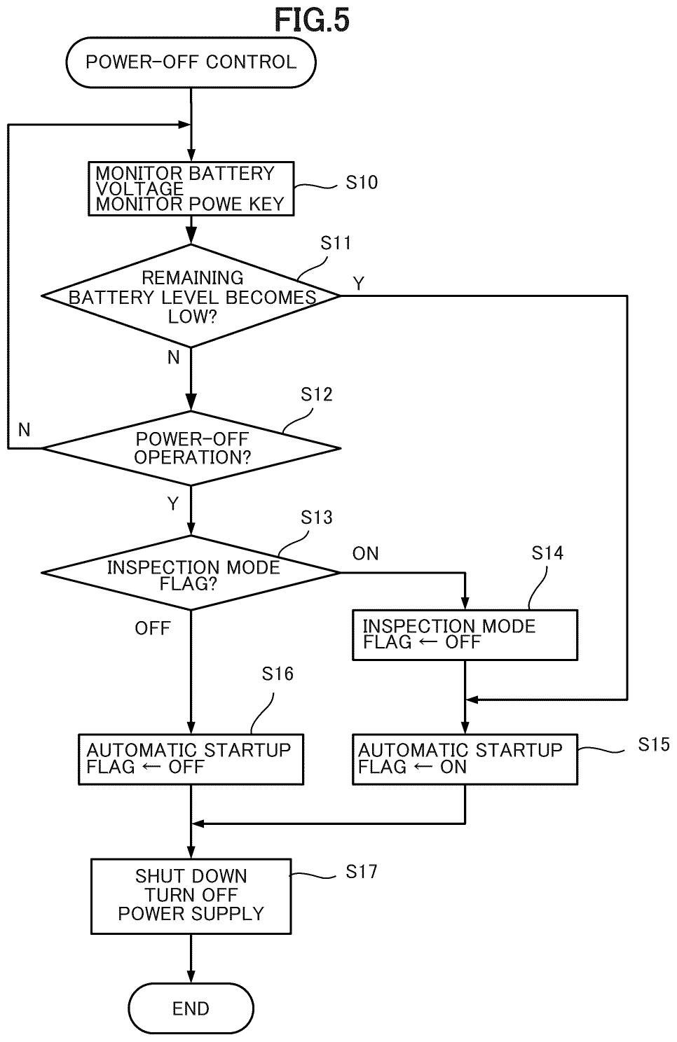

Next, a power-off control executed by the sub-microcomputer 251 of the power controller 250 is described with reference to FIG. 5. This processing is executed in a power ON state. In power control, an inspection mode flag that indicates an on/off setting of an inspection mode, and an automatic startup flag that indicates an on/off setting of an automatic startup are used. The inspection mode flag and the automatic startup flag are stored in the non-volatile memory. The inspection mode flag is set to ON at an initial stage at which a program for the power controller 250 is installed and set up.

First, the sub-microcomputer 251 monitors the output voltage of the battery 253 by the AD converter 2511 and monitors the depression state of the power key 241 by the input port 2514 (step S10). The sub-microcomputer 251 determines whether the voltage of the battery 253 becomes less than a predetermined voltage (operation reference voltage) and a remaining battery level becomes low (step S11). In a case where a determination is made that the remaining battery level does not fall below a reference level (No in step S11), the sub-microcomputer 251 determines whether a power-off operation is performed depending on whether the power key 241 is depressed for a long time (step S12). In a case where a determination is made that the power key 241 is not depressed for a long time and the power-off operation is not performed (No in step S12), the sub-microcomputer 251 returns the processing in the power-off control processing to step S10 to continue a battery voltage monitoring and a power key monitoring.

In a case where a determination is made that the remaining battery level falls below the reference level in step S11 (Yes in step S11), the sub-microcomputer 251 turns on the automatic startup flag (step S15), shuts down the main function unit 290 and turns off the power supply (step S17). On the other hand, in a case where a determination is made that the remaining battery level is not low (No in step S11) and that the power key 241 is depressed for a long time to perform the power-off operation (Yes in step S12), the sub-microcomputer 251 determines whether the inspection mode flag is ON or OFF (step S13). In a case where the inspection mode flag is ON (ON in step S13), the sub-microcomputer 251 turns off the inspection mode flag (step S14) and turns on the automatic startup flag (step S15). Then, the sub-microcomputer 251 shuts down the main function unit 290 and turns off the power supply (step S17).

In a case where the inspection mode flag is OFF in step S13 (OFF in step S13), the sub-microcomputer 251 turns off the automatic startup flag (step S16), shuts down the main function unit 290 and turns off the power supply (step S17).

As described above, the inspection mode flag is set to ON at an initial stage at which a program for the power controller 250 is installed. Hence, the inspection mode flag is ON at an inspection stage before shipment from a factory, and the automatic startup flag is set to ON in response to the power off operation being performed after completion of the pre-shipment inspection. Since the inspection mode flag is set to OFF in response to the power-off operation being performed in the pre-shipment inspection, the automatic startup flag is set to OFF in response to a user performing the power-off operation after the shipment.

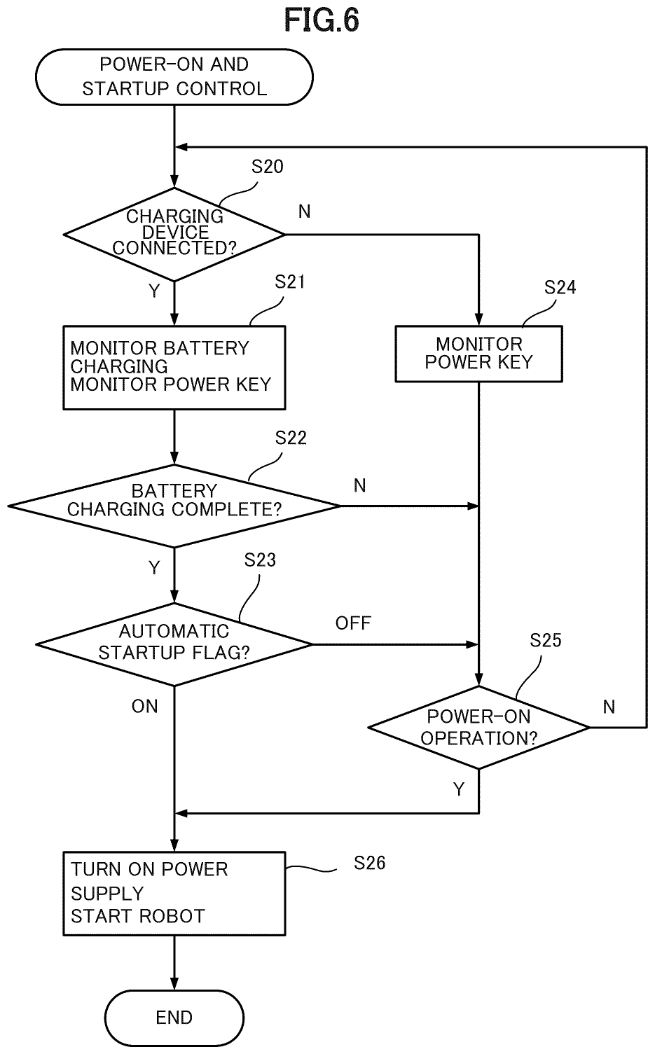

After turning off the power supply to the main function unit 290, the power controller 250 ends the power-off control, and executes power-on and startup control illustrated in FIG. 6. The power-on and startup control starts in a state where the power supply to the main function unit 290 is off.

The power controller 250 first determines whether a charging device is connected to the robot 200 depending on a charging signal at the input port 2512 indicating whether the robot 200 is charging (step S20). In a case where a determination is made that the charging device is connected (Yes in step S20), the power controller 250 monitors a charging state by a voltage of the battery 253 and a depression state of the power key 241 (step S21). In a case where a determination is made that the charging device is not connected (No in step S20), the power controller 250 monitors the depression state of the power key 241 (step S24). The power controller 250 determines, when monitoring the charging state of the battery 253 (step S21) in a state in which the charging device is connected (Yes in step S20), whether the voltage of the battery 253 exceeds the operation reference voltage and the charging is completed (step S22). The operation reference voltage is a minimum voltage necessary for operating the robot 200 normally, and is, for example, 75% of voltage at which the battery 253 is fully charged.

In a case where a determination is made that the voltage of the battery 253 exceeds the operation reference voltage and the charging is completed (Yes in step S22), the power controller 250 determines whether the automatic startup flag is ON or OFF (step S23). In a case where the automatic startup flag is ON (ON in step S23), the power controller 250 turns on the power supply to the main function unit 290, and starts the main function unit 290, that is, the robot 200 (step S26). If the automatic startup flag is OFF (OFF in step S23) in a case where a determination is made that the charging is completed (Yes in step S22), the power controller 250 determines whether the power key 241 is depressed for a long time to perform a power-on operation (step S25). In a case where a determination is made that the power-on operation is not performed (No in step S25), the power controller 250 returns the processing in the power-on and startup control to step S20 to repeat the processing from the determination of whether the charging device is connected to the robot 200. In a case where the power-on operation is performed (Yes in step S25), the power controller 250 turns on the power supply to the main function unit 290, and starts the main function unit 290, that is, the robot 200 (step S26).

In a case where determinations are made that the charging device is connected (Yes in step S20) and the charging of the battery 253 is not completed (No is step S22), the power controller 250 determines whether the power-on operation is performed (step S25), and, in response to determining that the power-on operation is not performed (No in step S25), returns the processing in the power-on and startup control to step S20 to repeat the processing from the determination of whether the charging device is connected to the robot 200. In a case where the charging of the battery 253 is not completed (No in step S22), in response to a determination that the power-on operation is performed (Yes in step S25), the power controller 250 turns on the power supply to the main function unit 290, and starts the main function unit 290, that is, the robot 200 (step S26).

On the other hand, in a case the charging device is not connected (No in step S20), the power controller 250 monitors the depression state of the power key 241 (step S24), determines whether the power-on operation is performed (step S25), and, in response to determining that the power-on operation is not performed (No in step S25), returns the processing in the power-on and startup control to step S20 to repeat the processing from the determination of whether the charging device is connected to the robot 200. In a case where the charging device is not connected (No in step S20), in response to a determination that the power-on operation is performed (Yes in step S25), the power controller 250 turns on the power supply to the main function unit 290, and starts the main function unit 290, that is, the robot 200 (step S26).

Note that the power controller 250 may turn on the automatic startup flag in step S26 in which the power supply is turned on to start the robot 200. Upon turning on the power supply to start the robot 200 (step S26), the power controller 250 ends the power-on and startup control. The inspection mode flag is ON at the time of the inspection before shipment of the robot 200 from a factory, and thus the automatic startup flag is set to ON in response to the power off operation being performed upon the completion of the inspection (step S15 of FIG. 5). Hence, the automatic startup flag is ON at the first time the user charges the battery 253 after the shipment and thus the power supply is turned on to start the robot 200 (ON in step S23 and step S26 of FIG. 6) upon completion of the charging of the battery 253 (Yes in step S22 of FIG. 6).

In a case where the user performs the power-off operation (Yes in step S12 of FIG. 5), the inspection mode flag is OFF (OFF in step S13 of FIG. 5), and thus the automatic startup flag is set to OFF (step S16 of FIG. 5). Hence, in a case where the user performs the power-off operation, since the automatic startup flag is OFF (OFF in step S23 of FIG. 6), the power supply is maintained at OFF (No in step S25 of FIG. 6) until the power-on operation is performed even if the charging of the battery is completed. Since the power of the battery is not consumed as long as the robot 200 is connected to the charging device, the time to full charge is shorter compared to a case where the robot 200 starts upon completion of charging.

On the other hand, in a case where the remaining battery level becomes low (Yes in step S11 of FIG. 5), the power controller 250 sets the automatic startup flag to ON (step S15 of FIG. 5), and turns off the power supply (step S17 of FIG. 5). In such a case, upon completion of the charging of the battery 253 (Yes in step S22 of FIG. 6), the power supply is turned on to start the robot 200 (step S26) since the automatic startup flag is ON (ON in step S23 of FIG. 6). In such a case, the user does not need to operate the power key 241, and thus, the lifelikeness of the robot 200 can be enhanced.

As described above, the robot 200 according to the present embodiment does not automatically start in response to the user performing the power-off operation, and automatically starts upon completion of charging in a case where the power-off operation is performed in the inspection mode, and thus the power-off operation performed by the user is prioritized, and also the lifelikeness of the robot can be enhanced.

Note that, instead of being stored in a non-volatile memory, the inspection mode flag may be set by an inspection mode switch provided in the robot 200. Furthermore, the inspection mode switch may be located in a hidden position. In such a case, the inspection mode switch is turned off after turning off the power upon completion of the inspection before shipment from a factory. In addition to being set to ON at an initial stage at which a program for the sub-microcomputer 251 is installed and the power controller 250 is set up, or being set using the inspection mode switch provided in the robot 200, the inspection mode flag may be settable in a case where the voltage of the battery 253 is lower than the operation reference voltage.

In the present embodiment, the power is turned on for automatic startup in a case where the automatic startup flag is ON when the charging of the battery is completed, but turning on of power and automatic startup may be combined with other conditions. For example, the power may be turned on for automatic startup when the charging of the battery is completed, the automatic startup flag is ON, and the surroundings of the robot 200 are bright. The surrounding brightness of the robot 200 can be sensed by the illuminance sensor 214. Furthermore, the robot 200 may be automatically started, instead of depending on the surrounding brightness, within a defined time range by referencing current time. For example, the power may be turned on for automatic startup in response to completion of the charging of the battery if the automatic startup flag is ON and the current time is between 7 a.m. and 10 p.m.

Furthermore, the reception means that receives the power-on operation and the power-off operation is not limited to the power key 241, and the power-on operation and the power-off operation may be received through a computer, a tablet terminal, a smartphone, or a remote controller connected to the robot 200. Connection between the robot 200, and the computer, the tablet terminal, the smartphone, and the remote controller may be wired or wireless connection.

The power controller and the control method of the present embodiment may be applied to not only the robot 200, but also to an apparatus driven by a battery. An apparatus other than the robot 200 can also improve user operability with respect to the power on/off and battery charging with the configuration of the present embodiment.

In the embodiment described above, operation programs executed by the CPUs of the processor 110 and the sub-microprocessor 251 are stored in advance in the ROM or the like of the storage unit 120. However, the present disclosure is not limited thereto, and the operation programs for executing the above-described various types of processing are installed on an existing general-purpose computer or the like, thereby causing that computer to function as a device corresponding to the apparatus control device 100 according to the embodiment.

Such programs may be provided by optional method, and, for example, may be stored in a non-transitory computer-readable recording medium, such as a flexible disk, a compact disc read-only memory (CD-ROM), a digital versatile disc read-only memory (DVD-ROM), a magneto-optical (MO) disc, a memory card, or a USB memory and may be distributed, or alternatively, may be stored in a storage on a network, such as the Internet, and may be provided by being downloaded.

Furthermore, in a case where the above-described processing is executed by sharing the work among an operating system (OS) and an application program or executed through cooperation between the OS and the application program, only the application program may be stored in a non-transitory recording medium or a storage. Furthermore, the program may be superimposed on a carrier wave and distributed via a network. For example, the program may be posted to a bulletin board system (BBS) on a network, and distributed via the network. Then, the program may be started and executed, as is similar to other application programs, under the control of the OS to execute the above-explained processing.

Furthermore, the processor 110 may be constituted by an optional processor alone such as a single processor, a multiprocessor, a multi-core processor, or the like, or may be constituted by a combination of these optional processors and processing circuity such as an application specific integrated circuit (ASIC), a field-programmable gate array (FPGA), or the like.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An apparatus, comprising:
an operation switch to switch power from ON to OFF; and
at least one processor, wherein
the at least one processor
sets, in response to the power being switched from ON to OFF by an operation on the operation switch in a state where an inspection mode flag is ON, an automatic startup flag to ON,
sets, in response to the power being switched from ON to OFF by the operation on the operation switch in a state where the inspection mode flag is OFF, the automatic startup flag to OFF,
switches, in response to detecting a remaining battery level of a battery being increased to a predetermined first value by charging to the battery in a state where the power is OFF and the automatic startup flag is ON, the power from OFF to ON to start the apparatus, and
maintains, in response to detecting the remaining battery level being increased to the predetermined first value by charging to the battery in a state where the power is OFF and the automatic startup flag is OFF, the power at OFF not to start the apparatus.

2. The apparatus according to claim 1, wherein
the at least one processor sets, in response to the power being switched from ON to OFF by an operation on the operation switch in a state where the inspection mode flag is ON, the automatic startup flag to ON and sets the inspection mode flag to OFF.

3. The apparatus according to claim 2, wherein
the at least one processor switches, in response to the remaining battery level decreasing to a predetermined second value in a state where the power is ON, the power from ON to OFF and sets the automatic startup flag to ON.

4. The apparatus according to claim 3, wherein
the operation switch is an operation switch to switch the power between ON and OFF, and
the at least one processor starts the apparatus in response to the power being switched from OFF to ON by an operation on the operation switch.

5. The apparatus according to claim 1, wherein
the inspection mode flag is set to ON at an initial stage at which the inspection mode flag is set up.

6. The apparatus according to claim 1, wherein
the predetermined first value is set to a value less than a remaining battery level when the battery is fully charged.

7. The apparatus according to claim 1, wherein
the at least one processor maintains the power at OFF not to start the apparatus upon detecting the remaining battery level is increased to the predetermined first value by charging to the battery in a state where the power is OFF and the automatic startup flag is ON, if a surrounding brightness is detected to be less than a predetermined brightness, or if a current time is a predetermined time.

8. The apparatus according to claim 1, further comprising:
a power receiving circuit to charge the battery wirelessly.

9. The apparatus according to claim 8, wherein
the apparatus is a pet-type robot comprising a head part and a torso part, and
the power receiving circuit is provided at the torso part.

10. A control method to be executed by an apparatus comprising an operation switch to switch power from ON to OFF, the control method comprising:
setting, in response to the power being switched from ON to OFF by an operation on the operation switch in a state where an inspection mode flag is ON, an automatic startup flag to ON,
setting, in response to the power being switched from ON to OFF by the operation on the operation switch in a state where the inspection mode flag is OFF, the automatic startup flag to OFF,
switching, in response to detecting a remaining battery level of a battery being increased to a predetermined first value by charging to the battery in a state where the power is OFF and the automatic startup flag is ON, the power from OFF to ON to start the apparatus, and
maintaining, in response to detecting the remaining battery level being increased to the predetermined first value by charging to the battery in a state where the power is OFF and the automatic startup flag is OFF, the power at OFF not to start the apparatus.

11. The control method according to claim 10, further comprising
setting the automatic startup flag to ON and setting the inspection mode flag to OFF in a case where the power is switched from ON to OFF by the operation on the operation switch with the inspection mode flag in the on-state,.

12. The control method according to claim 11, further comprising
switching the power from ON to OFF and setting the automatic startup flag to ON in response to the remaining battery level decreasing to a predetermined second value in a state where the power is ON.

13. The control method according to claim 12, wherein
the operation switch is an operation switch to switch the power between ON and OFF, and
the control method further comprising starting the apparatus in response to the power being switched from OFF to ON by an operation on the operation switch.

14. The control method according to claim 13, wherein
the inspection mode flag is set to ON at an initial stage at which the inspection mode flag is set up.

15. The control method according to claim 10, wherein
the predetermined first value is set to a value less than a remaining battery level when the battery is fully charged.

16. The control method according to claim 10, wherein
the power is maintained at OFF not to start the apparatus upon detecting the remaining battery level is increased to the predetermined first value by charging to the battery in a state where the power is OFF and the automatic startup flag is ON, if a surrounding brightness is detected to be less than a predetermined brightness, or if a current time is a predetermined time.

17. A non-transitory computer-readable recording medium storing a program, the program causing a computer of an apparatus comprising an operation switch to switch power from ON to OFF, to execute a control function comprising:
setting, in response to the power being switched from ON to OFF by an operation on the operation switch in a state where an inspection mode flag is ON, an automatic startup flag to ON,
setting, in response to the power being switched from ON to OFF by the operation on the operation switch in a state where the inspection mode flag is OFF, the automatic startup flag to OFF,
switching, in response to detecting a remaining battery level of a battery being increased to a predetermined first value by charging to the battery in a state where the power is OFF and the automatic startup flag is ON, the power from OFF to ON to start the apparatus, and
maintaining, in response to detecting the remaining battery level being increased to the predetermined first value by charging to the battery in a state where the power is OFF and the automatic startup flag is OFF, the power at OFF not to start the apparatus.

18. The non-transitory computer-readable recording medium according to claim 17, wherein
the control function further comprising setting the automatic startup flag to ON and setting the inspection mode flag to OFF in response to the power being switched from ON to OFF by an operation on the operation switch in a state where the inspection mode flag is ON.

19. The non-transitory computer-readable recording medium according to claim 18, wherein
the control function further comprising switching the power from ON to OFF and setting the automatic startup flag to ON in response to the remaining battery level decreasing to a predetermined second value in a state where the power is ON.

20. The non-transitory computer-readable recording medium according to claim 19, wherein
the operation switch is an operation switch to switch the power between ON and OFF, and
the control function further comprising starting the apparatus in response to the power being switched from OFF to ON by an operation on the operation switch.
